(19) United States
(12) Patent Application Publication
(10) Pub. No.: US 2026/0314630 A1
(43) Pub. Date: Oct. 15, 2026

(54) Evaporator for Smoothie Machine

(71) Applicant: Uni-Splendor Corporation, Tainan City (TW)

(72) Inventor: Yu-Yuan Lin, Tainan City (TW)

(21) Appl. No.: 19/179,945

(22) Filed: Apr. 15, 2025

(51) Int. Cl. A23G 9/22; F25B 39/02

(52) U.S. Cl. CPC A23G 9/22; F25B 39/02

(57) ABSTRACT

An evaporator for a smoothie machine comprises an outer cylinder including an outer annular wall and a top wall. An inner cylinder is disposed in a receiving space of the outer cylinder and includes an inner annular wall having a top end coupled with the top wall. An annular space is defined between the inner cylinder and the outer cylinder. A flange extends radially outward from a bottom portion of the inner annular wall and is coupled with a bottom portion of the outer annular wall to seal the annular space. The flange includes an inlet hole and an outlet hole. The inlet tube is axially received in the annular space. The inlet tube includes a lower end coupled with the inlet hole and a plurality of gas outlet holes. A refrigerant is guided into the annular space via the inlet tube and is discharged via the outlet hole.

### BACKGROUND OF THE INVENTION

The present invention relates to an evaporator for a smoothie machine and, more particularly, to an evaporator capable of enhancing the refrigeration efficiency of a smoothie machine.

A conventional smoothie machine generally includes a cylinder receiving a beverage. An evaporator is mounted in the cylinder, and rotatable scrape blades are mounted outside of the evaporator, such that the evaporator may absorb heat to reduce the temperature. Furthermore, the beverage in the cylinder comes in contact with the surface of the evaporator and, thus, can be refrigerated. Then, the scrape blades scrape the refrigerated beverage on the surface of the evaporator to produce slush-like products.

CN 101961063A discloses an evaporator including a cylindrical wall. A helical metal tube is mounted about an axis of the cylindrical wall of the evaporator. The refrigerant flows in the metal tube to absorb heat of the beverage on the outer side of the cylindrical wall of the evaporator via the metal tube, and the beverage can be refrigerated into smoothie.

However, an air gap exists between the metal tube and the cylindrical wall of the evaporator. The refrigerant absorbs the heat of the beverage on the outer side of the cylindrical wall via the tube wall of the metal tube and the air gap between the metal tube and the cylindrical wall, which has poor refrigeration efficiency, wastes energy, and requires a longer period of time to refrigerate the beverage in the container.

### BRIEF SUMMARY OF THE INVENTION

An objective of the present invention is to provide an evaporator capable of enhancing the refrigeration efficiency of a smoothie machine.

An evaporator for a smoothie machine according to the present invention comprises an outer cylinder, an inner cylinder, and an inlet tube. The outer cylinder is cylindrical and includes an outer annular wall and a top wall. The outer cylinder includes a receiving space in a central portion thereof. The inner cylinder is disposed in the receiving space and includes an inner annular wall and a central portion having a chamber. The inner annular wall has a top end coupled with the top wall. An annular space is defined between the inner cylinder and the outer cylinder. A flange extends radially outward from a bottom portion of the inner annular wall and is coupled with a bottom portion of the outer annular wall, such that the annular space is a substantially sealed space. The flange includes an inlet hole and an outlet hole. The inlet tube is axially received in the annular space. The inlet tube includes a lower end coupled with the inlet hole. The inlet tube further includes a plurality of gas outlet holes. A refrigerant is guided into the annular space via the inlet tube and is discharged via the outlet hole.

In an example, the evaporator further comprises an outlet tube disposed outside of the inner cylinder and coupled with the outlet hole.

In an example, the evaporator further comprises a thermally insulating member disposed in the chamber of the inner cylinder.

In an example, the top wall of the outer cylinder includes an upper through-hole in a central portion of the top wall. The thermally insulating member includes an axial hole aligned with the upper through-hole. The evaporator further includes a bottom board disposed below the thermally insulating member to seal a bottom portion of the chamber. The bottom board includes a lower through-hole aligned with the axial hole.

In an example, the evaporator further comprises a guiding plate axially disposed in the annular space and located on a side of the inlet tube. The guiding plate includes a plurality of vents. A gap exists between the guiding plate and the outer annular wall.

In an example, the guiding plate is arcuate.

In an example, the inner cylinder is substantially cylindrical and is received in the receiving space and coaxial to the outer cylinder.

In an example, the smoothie machine includes a container, a transmission device, a stirring device, a condenser, and a compressor, wherein the container is configured to receive a beverage, is disposed around the evaporator, and includes an outlet on a side of the container. The transmission device includes a motor and a shaft driven by the motor to rotate. The shaft extends through the lower through-hole, the axial hole, and the upper through-hole of the evaporator and is coupled with the stirring device. The stirring device is disposed in the container and includes an upper end having a central portion coupled with the shaft to permit joint rotation of the shaft and the stirring device. The stirring device includes a plurality of stirring blades disposed around an outer periphery of the outer annular wall. The condenser is connected to the inlet tube of the evaporator and the compressor. The compressor is connected to the outlet tube. Thus, the compressor, the condenser, and the evaporator form a cooling loop, and the refrigerant is received in the cooling loop.

In practice of the present invention, the beverage is placed into the container. The condenser, the compressor, and the transmission device are activated. The refrigerant is used to cool the beverage on the outer side of the outer annular wall is cooled by the evaporator 1. The gasified refrigerant in the annular space may be in direct contact with the outer annular wall without hindrance, such that the heat of the beverage on the outer side of the outer annular wall 111 may be directly absorbed, thereby rapidly cooling the beverage. Furthermore, the thermally insulating member on the inner side of the inner annular wall of the inner cylinder may reduce the absorption of the heat in the interior of the inner cylinder by the refrigerant, thereby avoiding reduction in the heat absorption via the outer side of the outer cylinder. Therefore, according to the present invention, the gasified refrigerant is in direct contact with the outer annular wall to absorb the heat from the outer side, thereby significantly increasing the refrigeration efficiency and the energy saving effect of the evaporator 1.

The present invention will become clearer in light of the following detailed description of illustrative embodiments of this invention described in connection with the drawings.

### DESCRIPTION OF THE DRAWINGS

FIG. 1 is an exploded, perspective view of an evaporator for a smoothie machine according to the present invention.

FIG. 2 is a schematic perspective view of the smoothie machine according to the present invention.

FIG. 3 is a cross sectional view taken along section line A-A of FIG. 2.

FIG. 4 is a cross sectional view taken along section line B-B of FIG. 2.

FIG. 5 is a schematic view illustrating operation of the evaporator for a smoothie machine according to the present invention.

### DETAILED DESCRIPTION OF THE INVENTION

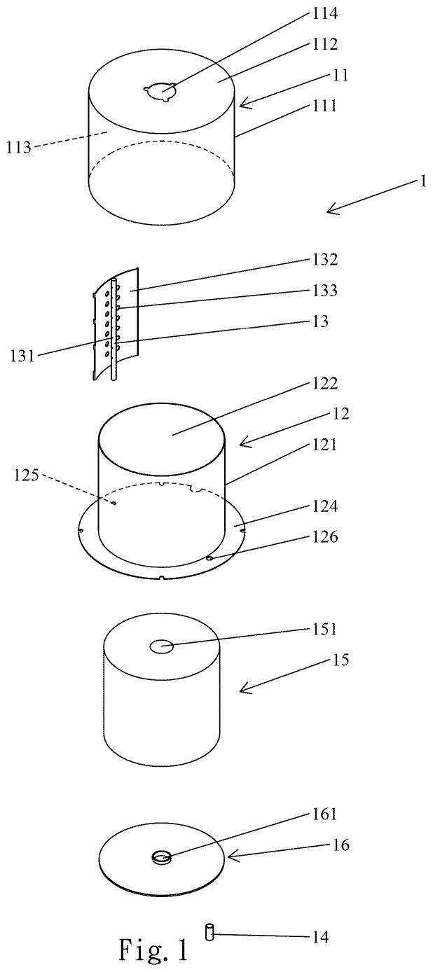

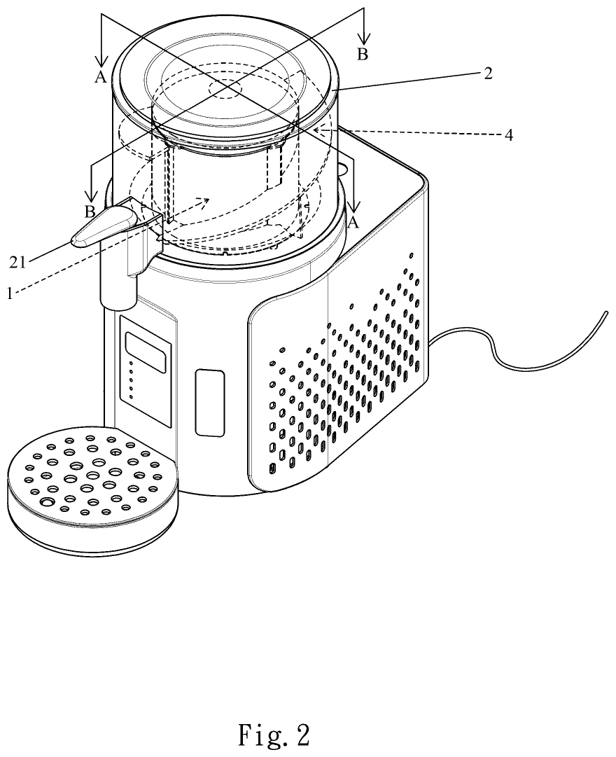

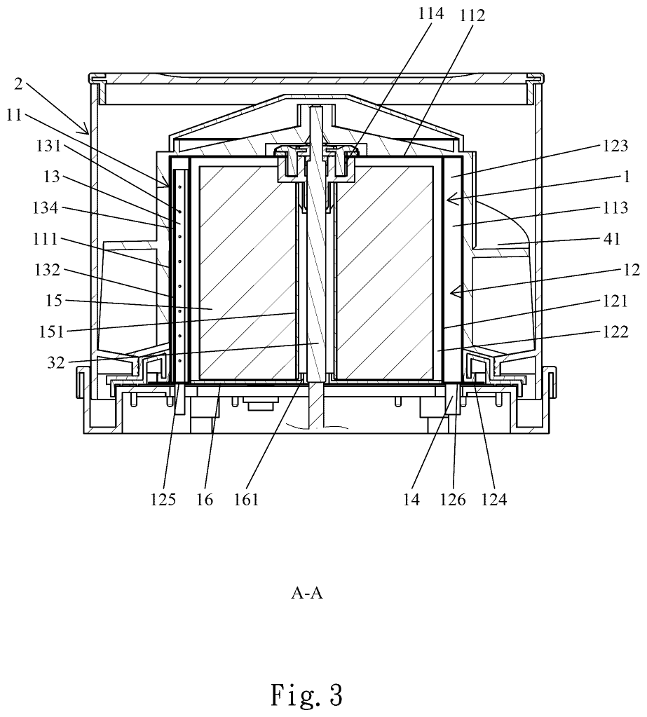

With reference to FIGS. 1-3, an evaporator for a smoothie machine according to the present invention comprises an outer cylinder 11, an inner cylinder 12, an inlet tube 13, an outlet tube 14, a thermally insulating member 15, and a bottom board 16. The outer cylinder 11 is a cylindrical object made of metal. The outer cylinder 11 includes an outer annular wall 111 and a top wall 112. The outer cylinder 11 further includes a receiving space 113 in a central portion thereof. Furthermore, the top wall 112 includes a central portion having an upper through-hole 114.

The inner cylinder 12 is a substantially cylindrical object and has a diameter smaller than the diameter of the outer cylinder 11. The inner cylinder 12 is received in the receiving space 113 and is coaxial to the outer cylinder 11. The inner cylinder 12 includes an inner annular wall 121 and a central portion having a chamber 122. The top end of the inner annular wall 121 may be coupled with the top wall 112 of the outer cylinder 11 by welding or any other suitable methods. An annular space 123 is defined between the inner cylinder 12 and the outer cylinder 11. A flange 124 extends radially outward from a bottom portion of the inner annular wall 121 and is coupled with a bottom portion of the outer annular wall 111 by welding or any other suitable methods, such that the annular space 123 is a substantially sealed space. The flange 124 includes an inlet hole 125 and an outlet hole 126 opposite to the inlet hole 125.

The inlet tube 13 is axially received in the annular space 123 and includes a lower end coupled with the inlet hole 125. The inlet tube 13 further includes a plurality of gas outlet holes 131. The evaporator 1 further comprises a guiding plate 132 made of metal and may be in the form of an arcuate member axially disposed in the annular space 123 and located on a side of the inlet tube 13. The guiding plate 132 includes a plurality of vents 133. A gap 134 exists between the guiding plate 132 and the outer annular wall 111, and most area of the guiding plate 132 does not abut the outer annular wall 111.

The outlet tube 14 is disposed outside of the inner cylinder 12 and is coupled with the outlet hole 126.

The thermally insulating member 15 is made of polymeric foam or any other materials with excellent thermal insulating properties. The thermally insulating member 15 is disposed in the chamber 122 of the inner cylinder 12 and includes a central portion having an axial hole 151 aligned with the upper through-hole 114 of the outer cylinder 11.

The bottom board 16 is disposed below the thermally insulating member 15 and may seal the bottom portion of the chamber 122. Furthermore, the bottom board 16 includes a central portion having a lower through-hole 161 aligned with the axial hole 151.

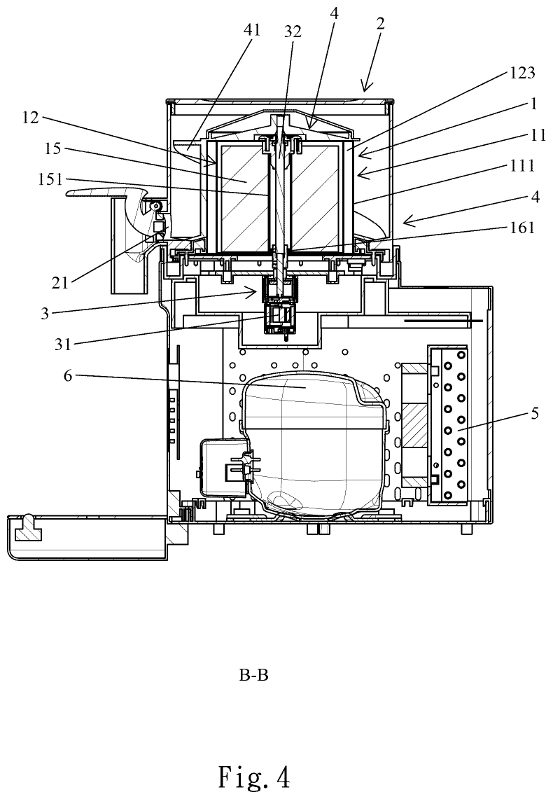

With reference to FIGS. 1-4, the smoothie machine according to the present invention further comprises a container 2, a transmission device 3, a stirring device 4, a condenser 5, and a compressor 6. The container 2 is configured to receive a beverage (not shown), is disposed around the evaporator 1, and includes an outlet 21 on a side of the container 2.

The transmission device 3 includes a motor 31 and a shaft 32 driven by the motor 31 to rotate. The shaft 32 extends through the lower through-hole 161, the axial hole 151, and the upper through-hole 114 of the evaporator 1 and is coupled with the stirring device 4.

The stirring device 4 is disposed in the container 2 and includes an upper end having a central portion coupled with the shaft 32 to permit joint rotation of the shaft 32 and the stirring device 4. The stirring device 41 includes a plurality of stirring blades 41 disposed around an outer periphery of the outer annular wall 111. The stirring blades 41 are configured to push the beverage and to scrape refrigerated beverage on the outer annular wall 111 of the evaporator 1.

The condenser 5 is connected to the inlet tube 13 of the evaporator 13 via a tube (not shown) and is connected to the compressor 6 via another tube (not shown).

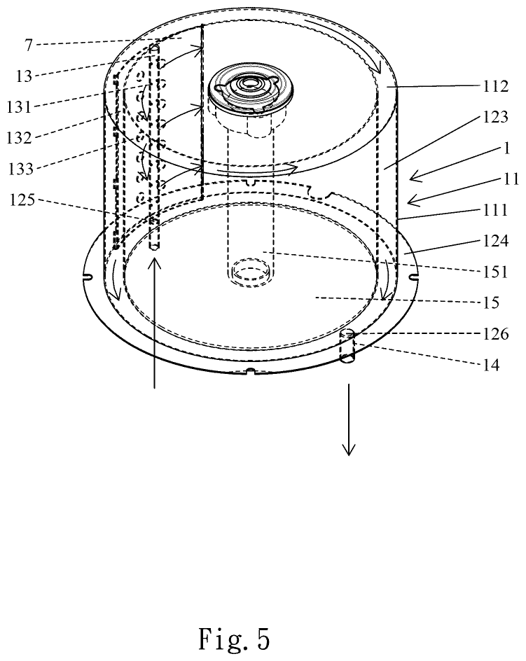

The compressor 6 is connected to the outlet tube 14 via a further tube (not shown). Thus, the compressor 6, the condenser 5, and the evaporator 1 form a cooling loop, and a refrigerant 7 is received in the cooling loop, as shown in FIG. 5.

With reference to FIGS. 1-5, in practice of the smoothie machine according to the present invention, the beverage is placed into the container 2. The condenser 5, the compressor 6, and the transmission device 3 are activated. The refrigerant 7 is compressed by the compressor 6 and then moves into the condenser 5 where the heat energy of the refrigerant 7 is released. The refrigerant 7 outputted by the condenser 5 passes through the tube to reduce the pressure and then enters the inlet tube 13 of the evaporator 1. The gasified refrigerant 7 is guided by the gas outlet hole 131 into the annular space 123 of the evaporator 1. The beverage on the outer side of the outer annular wall 111 is cooled by the evaporator 1. A portion of the gasified refrigerant 7 outputting from the gas outlet hole 131 may cool the outer annular wall 11 on a side of the guiding plate 132. Thus, the guiding plate 132 may guide most of the gasified refrigerant 7 outputted from the gas outlet hole 131 into a place in the annular space 123 distant to the inlet tube 13, avoiding concentration of the gasified refrigerant 7 in the inlet tube 13 to thereby provide a more uniform refrigeration effect.

According to the present invention, the gasified refrigerant 7 in the annular space 123 may be in direct contact with the outer annular wall 111 without hindrance, such that the heat of the beverage on the outer side of the outer annular wall 111 may be directly absorbed, thereby rapidly cooling the beverage. Furthermore, the thermally insulating member 15 on the inner side of the inner annular wall 121 of the inner cylinder 12 may reduce the absorption of the heat in the interior of the inner cylinder 12 by the refrigerant 7, thereby avoiding reduction in the heat absorption via the outer side of the outer cylinder 11. Therefore, according to the present invention, the gasified refrigerant 7 is in direct contact with the outer annular wall 111 to absorb the heat from the outer side, thereby significantly increasing the refrigeration efficiency and the energy saving effect of the evaporator 1. Furthermore, the beverage may be cooled more rapidly, and the stirring blades 41 of the stirring device 4 may scrape the slush-like beverage smoothie on the outer annular wall 111, and the beverage is then guided to the outside via the outlet 21 of the container 2. Furthermore, after absorbing heat energy, the gasified refrigerant 7 may pass through the outlet hole 126 and the outlet tube 14 of the evaporator 1 and the compressor 6, thereby maintaining the cooling loop permitting the evaporator 1 to continuously refrigerate the beverage.

In view of the foregoing, the present invention may significantly increase the refrigeration efficiency of the evaporator of the smoothie machine. The foregoing embodiments are examples of the present invention, not limitation to the present invention. All equivalent changes made in accordance with the spirit of the present invention should also fall within the scope of the present invention.

1. An evaporator for a smoothie machine, with the evaporator comprising:
an outer cylinder which is cylindrical and includes an outer annular wall and a top wall, wherein the outer cylinder includes a receiving space in a central portion thereof;
an inner cylinder disposed in the receiving space, wherein the inner cylinder includes an inner annular wall and a central portion having a chamber, wherein the inner annular wall has a top end coupled with the top wall, wherein an annular space is defined between the inner cylinder and the outer cylinder, wherein a flange extends radially outward from a bottom portion of the inner annular wall and is coupled with a bottom portion of the outer annular wall, such that the annular space is a substantially sealed space, and wherein the flange includes an inlet hole and an outlet hole; and
an inlet tube axially received in the annular space, wherein the inlet tube includes a lower end coupled with the inlet hole, wherein the inlet tube further includes a plurality of gas outlet holes, and wherein a refrigerant is guided into the annular space via the inlet tube and is discharged via the outlet hole.

2. The evaporator for the smoothie machine as claimed in claim 1, further comprising an outlet tube disposed outside of the inner cylinder and coupled with the outlet hole.

3. The evaporator for the smoothie machine as claimed in claim 1, further comprising a thermally insulating member disposed in the chamber of the inner cylinder.

4. The evaporator for the smoothie machine as claimed in claim 3, wherein the top wall of the outer cylinder includes an upper through-hole in a central portion of the top wall, wherein the thermally insulating member includes an axial hole aligned with the upper through-hole, wherein the evaporator further includes a bottom board disposed below the thermally insulating member to seal a bottom portion of the chamber, and wherein the bottom board includes a lower through-hole aligned with the axial hole.

5. The evaporator for the smoothie machine as claimed in claim 1, further comprising a guiding plate axially disposed in the annular space and located on a side of the inlet tube, wherein the guiding plate includes a plurality of vents, and wherein a gap exists between the guiding plate and the outer annular wall.

6. The evaporator for the smoothie machine as claimed in claim 5, wherein the guiding plate is arcuate.

7. The evaporator for the smoothie machine as claimed in claim 1, wherein the inner cylinder is substantially cylindrical and is received in the receiving space and coaxial to the outer cylinder.

8. The evaporator for the smoothie machine as claimed in claim 4, further comprising an outlet tube disposed outside of the inner cylinder and coupled with the outlet hole, wherein the smoothie machine includes a container, a transmission device, a stirring device, a condenser, and a compressor, wherein the container is configured to receive a beverage, is disposed around the evaporator, and includes an outlet on a side of the container, wherein the transmission device includes a motor and a shaft driven by the motor to rotate, wherein the shaft extends through the lower through-hole, the axial hole, and the upper through-hole of the evaporator and is coupled with the stirring device, wherein the stirring device is disposed in the container and includes an upper end having a central portion coupled with the shaft to permit joint rotation of the shaft and the stirring device, wherein the stirring device includes a plurality of stirring blades disposed around an outer periphery of the outer annular wall, wherein the condenser is connected to the inlet tube of the evaporator and the compressor, wherein the compressor is connected to the outlet tube, such that the compressor, the condenser, and the evaporator form a cooling loop, and the refrigerant is received in the cooling loop.
